(19) United States
(12) Patent Application Publication
(10) Pub. No.: US 2024/0119569 A1
(43) Pub. Date: Apr. 11, 2024

(54) IMAGE PROCESSING APPARATUS AND IMAGE PROCESSING METHOD

(71) Applicant: Panasonic Intellectual Property Management Co., Ltd., Osaka (JP)

(72) Inventors: Yuzuru NAKAMURA, Osaka (JP); Tadamasa TOMA, Osaka (JP); Sotaro TSUKIZAWA, Osaka (JP)

(73) Assignee: Panasonic Intellectual Property Management Co., Ltd., Osaka (JP)

(21) Appl. No.: 18/542,622

(22) Filed: Dec. 16, 2023

Related U.S. Application Data
(63) Continuation of application No. PCT/JP2022/012838, filed on Mar. 18, 2022.

(30) Foreign Application Priority Data
Jun. 24, 2021 (JP) 2021-104942

(51) Int. Cl. G06T 5/70; G06T 5/20; G06T 7/11; G06V 10/30; G06V 20/64

(52) U.S. Cl. CPC G06T 5/70; G06T 5/20; G06T 7/11; G06V 10/30; G06V 20/64; G06T 2207/10028; G06T 2207/20021; G06T 2207/20212

(57) ABSTRACT

An input interface acquires a first distance image including a plurality of pixels, each of the plurality of pixels indicating a distance value from an image capture device to each point of an object. An image divider divides the first distance image into a plurality of pixel groups based on the distance values of the pixels, such that each of the plurality of pixel groups includes pixels having distance values falling within one of a plurality of distance intervals different from each other. A noise filter individually processes the plurality of pixel groups using a plurality of filter parameters different for the plurality of pixel groups, to reduce noises in the plurality of pixel groups. An image combiner combines the plurality of pixel groups processed by the noise filter, with each other, to generate a second distance image.

This is a continuation application of International Application No, PCT/JP2022/012838, with an international filing date of Mar. 18, 2022, which claims priority of Japanese patent application No. 2021-104942 fled on Jun. 24, 2021, the content of which is incorporated herein by reference.

### BACKGROUND

### 1. Technical Field

The present disclosure relates to an image processing apparatus and an image processing method.

### 2. Description of Related Art

There are image capture device that acquire a distance image including a plurality of pixels each indicating a distance value to a corresponding point of an object, such as a time-of-flight (ToF) camera and the like.

For example, Japanese Patent No. JP 6814053 B discloses an object position detection device that outputs a distance image indicating the position of an object, such as a person. Japanese Patent No. JP 6793055 B discloses a filter processing device that filters three-dimensional distance image data inputted from a three-dimensional sensor.

### SUMMARY

A distance image includes random noises, due to insufficient sensitivity of imaging elements, thermal noises in imaging elements and circuits, and the like. Therefore, it is necessary to reduce such noise. The distance image can be considered as three-dimensional data with coordinates in vertical, horizontal, and depth directions, as seen from the image capture device. At the same time, the distance image is formally two-dimensional data, and therefore, two-dimensional image processing can be applied to the distance image. However, if noise reduction techniques used in conventional image processing, such as median filtering, are simply applied to the distance image, then the noise may be rather amplified, and defective pixels may be rather increased. Therefore, it is necessary to reduce noises in the distance image more reliably than the prior art.

The present disclosure provides an image processing apparatus and an image processing method capable of reducing noises in a distance image more reliably than the prior art.

According to an aspect of the present disclosure, an image processing apparatus is provided with an input interface, an image divider, a noise filter, and an image combiner. The input interface acquires a first distance image including a plurality of pixels, each of the plurality of pixels indicating a distance value from an image capture device to each point of an object. The image divider divides the first distance image into a plurality of pixel groups based on the distance values of the pixels, such that each of the plurality of pixel groups includes pixels having distance values falling within one of a plurality of distance intervals different from each other. The noise filter individually processes the plurality of pixel groups using a plurality of filter parameters different for the plurality of pixel groups, to reduce noises in the plurality of pixel groups. The image combiner combines the plurality of pixel groups processed by the noise filter, with each other, to generate a second distance image.

The image processing apparatus according to one aspect of the present disclosure can reduce noises in the distance image more reliably than the prior art.

### BRIEF DESCRIPTION OF DRAWINGS

FIG. 1 is a schematic diagram illustrating a configuration of an image processing apparatus 2 according to a first embodiment;

FIG. 2 is a flowchart illustrating noise reduction process executed by a processing circuit 20 of FIG. 1;

FIG. 3 illustrates an example of a distance image 40 to be processed by the image processing apparatus 2 of FIG. 1;

FIG. 4 is a diagram illustrating a pixel group 40a corresponding to a distance interval D1, among pixels included in the distance image 40 of FIG. 3;

FIG. 5 is a diagram illustrating a pixel group 40b corresponding to the distance interval D2, among the pixels included in the distance image 40 of FIG. 3;

FIG. 6 is a diagram illustrating a pixel group 40c corresponding to the distance interval D3, among the pixels included in the distance image 40 of FIG. 3;

FIG. 7 is a diagram illustrating a pixel group 40d corresponding to a distance interval D4, among the pixels included in the distance image 40 of FIG. 3;

FIG. 8 is a diagram illustrating a pixel group 40e corresponding to a distance interval D5, among the pixels included in the distance image 40 of FIG. 3;

FIG. 9 is a diagram illustrating a pixel group 40a′ obtained by processing the pixel group 40a of FIG. 4 using a noise filter 25;

FIG. 10 is a diagram illustrating a pixel group 40b′ obtained by processing the pixel group 40b of FIG. 5 using the noise filter 25;

FIG. 11 is a diagram illustrating a pixel group 40c′ obtained by processing the pixel group 40c of FIG. 6 using the noise filter 25;

FIG. 12 is a diagram illustrating a pixel group 40d′ obtained by processing the pixel group 40d of FIG. 7 using the noise filter 25;

FIG. 13 is a diagram illustrating a pixel group 40e′ obtained by processing the pixel group 40e of FIG. 8 using the noise filter 25;

FIG. 14 is a diagram illustrating a distance image 40′ obtained by combining the pixel groups 40a′ to 40e′ of FIGS. 9 to 13;

FIG. 15 is a schematic diagram illustrating a configuration of an image processing apparatus 2A according to a second embodiment;

FIG. 16 is a flowchart illustrating noise reduction process executed by a processing circuit 20A in FIG. 15;

FIG. 17 is a schematic diagram illustrating a configuration of an image processing apparatus 2B according to a third embodiment; and

FIG. 18 is a schematic diagram illustrating a configuration of an image processing apparatus 2C according to a fourth embodiment.

### DETAILED DESCRIPTION

Hereinafter, embodiments will be described in detail with reference to the drawings as appropriate. However, excessively detailed explanation may be omitted. For example, detailed explanation of well-known matters may be omitted, and redundant explanations on substantially the same configuration may be omitted. This is to avoid the unnecessary redundancy of the following description, and to facilitate understanding by those skilled in the art.

It is to be noted that the inventor(s) intends to provide the accompanying drawings and the following description so that those skilled in the art can sufficiently understand the present disclosure, and does not intend to limit subject matters recited in the claims.

### First Embodiment

### Configuration of First Embodiment

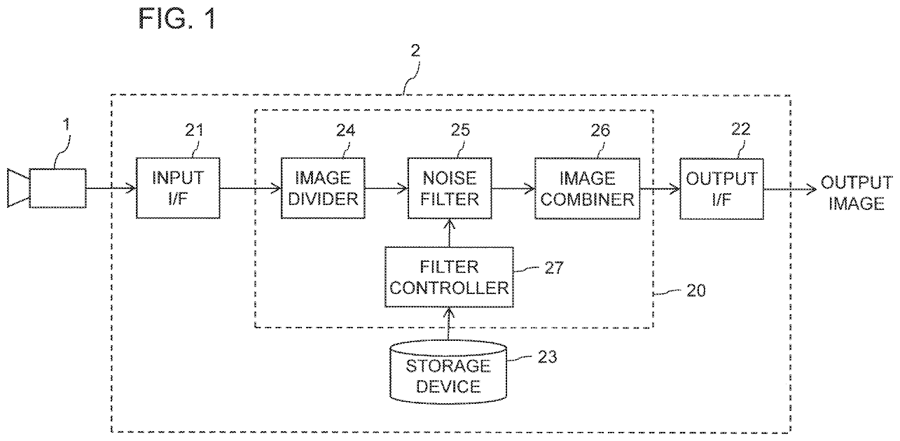

FIG. 1 is a schematic diagram illustrating a configuration of an image processing apparatus 2 according to a first embodiment. The image processing apparatus 2 acquires a distance image from an image capture device 1, and reduces noises included in the distance image, such as random noises.

The image capture device 1 generates a distance image including a plurality of pixels, each pixel indicating a distance value from the image capture device 1 to a corresponding point on an object. The image capture device 1 may be a time-of-flight (ToF) camera, a light detection and ranging (LiDAR) camera, a stereo camera, or the like.

The image processing apparatus 2 is provided with a processing circuit 20, an input interface (I/F) 21, an output interface (I/F) 22, and a storage device 23. The processing circuit 20 includes an image divider 24, a noise filter 25, an image combiner 26, and a filter controller 27.

The input interface 21 acquires a distance image from the image capture device 1, and passes the distance image to the image divider 24 of the processing circuit 20. The input interface 21 may be a signal interface, such as a universal serial bus (USB), Ethernet (registered trademark), or the like.

The image divider 24 acquires the distance image from the image capture device 1 via the input interface 21, and divides the distance image into a plurality of pixel groups based on the distance values of the pixels. That is, the image divider 24 divides the distance image into the plurality of pixel groups based on the distance values of the pixels, such that each of the plurality of pixel groups includes pixels having the distance values falling within one of a plurality of distance intervals different from each other. Each of the distance intervals is a partial interval of the distance from the image capture device 1 to a point on the object. Each of the plurality of pixel groups has a representative distance value representative of the distance values of the pixels belonging to the pixel group. The representative distance value may be, e.g., a minimum, maximum, or average of the distance values of the pixels belonging to the pixel group.

The noise filter 25 individually processes the plurality of pixel groups using a plurality of filter parameters different for the plurality of pixel groups, to reduce noises in the plurality of pixel groups. The noise filter 25 includes, for example, one or more median filters. The noise filter 25 may process the plurality of pixel groups sequentially, or process the plurality of pixel groups in parallel.

The plurality of filter parameters for the plurality of pixel groups are stored in the storage device 23 in advance. The plurality of filter parameters are set, for example, such that noise reduction the performance of the noise filter 25 decreases as the representative distance value of the pixel group increases. As the performance of the noise filter 25 increases, the noises can be better reduced or removed, but defective pixels are more likely occur. The filter parameters include, for example, the window width of the filter.

The filter controller 27 reads the filter parameters from the storage device 23, and sets the filter parameters to the noise filter 25. The filter controller 27 sets the filter parameters to the noise filter 25 per pixel group.

The image combiner 26 combines the plurality of pixel groups processed by the noise filter 25, with each other, to generate a distance image.

The output interface 22 sends the distance image generated by the image combiner 26 to a subsequent processing device (not shown). The output interface 22 may be a signal interface, such as a USB, Ethernet (registered trademark), or the like. The processing device in the subsequent stage may include an image recognizer.

The processing circuit 20 may be provided with a plurality of dedicated circuits corresponding to the image divider 24, the noise filter 25, the image combiner 26, and the filter controller 27, respectively. Alternatively, the processing circuit 20 may be provided with one or more general-purpose processors or dedicated processors (e.g., a digital signal processor) which, when executing a program, operates as the image divider 24, the noise filter 25, the image combiner 26, and the filter controller 27, respectively.

The image processing apparatus 2 may process a still image to reduce noises therein, or may process a video to reduce noises therein.

### Operation of First Embodiment

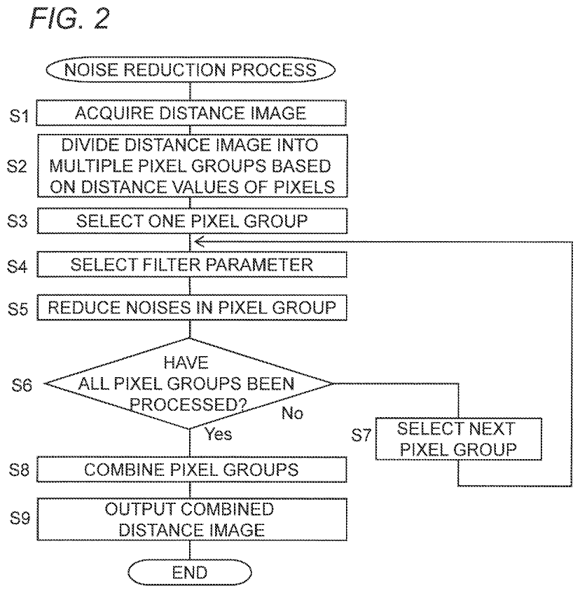

FIG. 2 is a flowchart illustrating noise reduction process executed by the processing circuit 20 in FIG. 1.

The processing circuit 20 acquires a distance image from the image capture device 1 via the input interface 21 (step S1).

The processing circuit 20 then divides the distance image into a plurality of pixel groups based on the distance values of the pixels (step S2).

Steps S1 and S2 correspond to the operation of the processing circuit 20 as the image divider 24.

The processing circuit 20 then selects one of the plurality of pixel groups divided in step S2 (step S3).

The processing circuit 20 then selects a filter parameter corresponding to the pixel group selected in step S3, reads the selected filter parameter from the storage device 23, and sets the filter parameter to the noise filter 25 (step S4).

As described above, the filter parameters include, for example, the window width of the filter. Let i=0, 1, . . . , k be the pixel groups, i=0 being the pixel group closest to the image capture device 1, and i=k being the pixel group farthest from the image capture device 1. For example, the window width “hᵢ” for each of the pixel groups is defined as follows.

hᵢ=h₀−(a×i)+λg

Where “h₀” denotes an initial window width, “a” denotes a window width reduction factor, “g” denotes a gain of the image capture device 1, and “λ” denotes a mixing ratio. The window width hᵢ is always set to zero or more.

According to the equation of the window width hᵢ, the more distant the pixel group is located from the image capture device 1, the smaller the window width hᵢ is. Therefore, the filter parameters are set such that the performance of the noise filter 25 decreases as the representative distance value of the pixel group increases.

The processing circuit 20 then processes the pixel group to reduce the noises in the pixel group, in accordance with the filter parameter being set (step S5).

The processing circuit 20 then determines whether or not all the pixel groups has been processed to reduce noises (step S6): if YES, the process proceeds to step S8; and if NO, the process proceeds to step S7.

The processing circuit 20 then selects a next unselected pixel group from the plurality of pixel groups divided in step S2 (step S7), and then repeats steps S4 to S6.

Steps S3 and S5 to S7 correspond to the operation of the processing circuit 20 as the noise filter 25, and step S4 corresponds to the operation of the processing circuit 20 as the filter controller 27.

The processing circuit 20 then combines the plurality of pixel groups processed to reduce the noises, and thus, generates a distance image (step S8).

The processing circuit 20 then outputs the combined distance image to the subsequent processing device via the output interface 22 (step S9).

Steps S8 to S9 correspond to the operation of the processing circuit 20 as the image combiner 26.

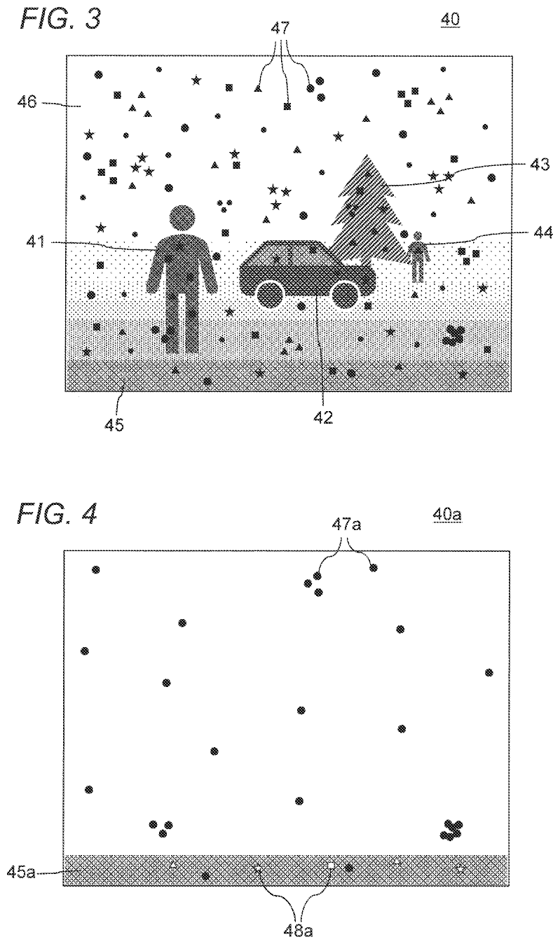

Next, an exemplary noise reduction process executed by the image processing apparatus 2 of FIG. 1 will be described with reference to FIGS. 3 to 14.

FIG. 3 illustrates an example of a distance image 40 to be processed by the image processing apparatus 2 of FIG. 1. The distance image 40 includes objects 41 to 44, ground 45, and background 46. The objects 41 to 44 include, for example, a person, an automobile, a tree, and the like. The background 46 is substantially points at infinity, and its pixels have a distance value of zero (or do not have any distance value). The distance image 40 also includes noises 47. The noises 47 are pixels or areas having distance values discontinuous from those of the surrounding pixels, due to insufficient sensitivity of the imaging elements, thermal noises in the imaging elements and the circuits, and the like.

In FIG. 3 and others, the noises 47 are indicated as large circles, quadrangles, stars, triangles, and small circles, for purpose of explanation. However, in practice, most of the noises 47 that are random noises do not form continuous areas, and are made of isolated pixels.

As described above, the image divider 24 divides the distance image into the plurality of pixel groups based on the distance values of the pixels, such that each of the plurality of pixel groups includes pixels having distance values falling within one of the plurality of distance intervals different from each other. In the example of FIGS. 3 to 14, the distance from the image capture device 1 to the points on the objects are divided into five distance intervals D1 to D5. In the example herein, the distance interval D1 is an interval including distance values from 0 to 5 meters; the distance interval D2 is an interval including the distance values from 5 to 10 meters; the distance interval D3 is an interval including distance values from 10 to 15 meters; the distance interval D4 is an interval including distance values from 15 to 20 meters; and the distance interval D5 is an interval including distance values from 20 meters or more.

FIG. 4 is a diagram illustrating a pixel group 40a corresponding to the distance interval D1, among the pixels included in the distance image 40 of FIG. 3. The pixel group 40a includes the pixels corresponding to ground 45a and noises 47a. The pixel group 40a also includes defective pixels 48a that are pixels having distance values corresponding to objects, grounds, noises belonging to other pixel groups, that is, pixels having distance values not falling within the distance interval D1. Since the pixels corresponding to the defective pixels 48a belong to other pixel groups, the defective pixels 48a in the pixel group 40a have a distance value of zero (or do not have any distance value).

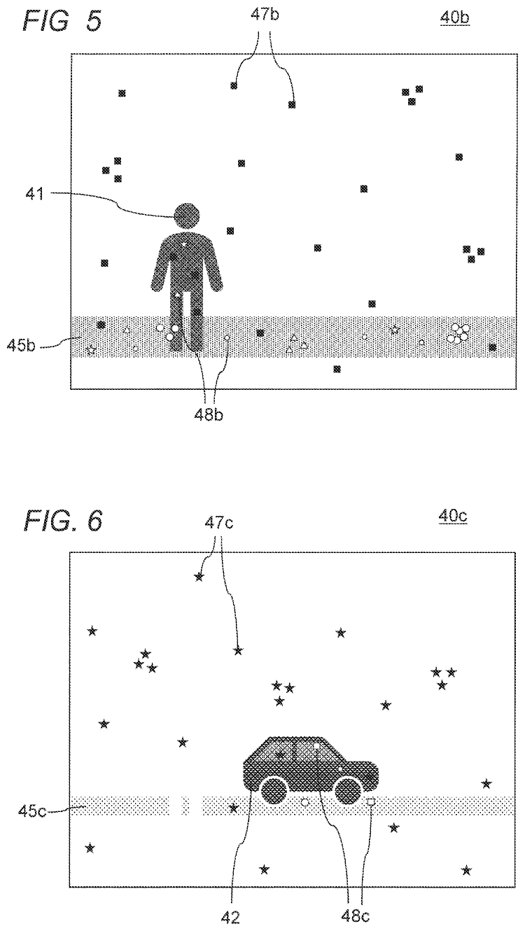

FIG. 5 is a diagram illustrating a pixel group 40b corresponding to the distance interval D2, among the pixels included in the distance image 40 of FIG. 3. The pixel group 40b include the pixels corresponding to an object 41, a ground 45b, noises 47b, and defective pixels 48b.

FIG. 6 is a diagram illustrating a pixel group 40c corresponding to the distance interval D3, included in the distance image 40 of FIG. 3. The pixel group 40c includes the pixels corresponding to an object 42, a ground 45c, noises 47c, and defective pixels 48c.

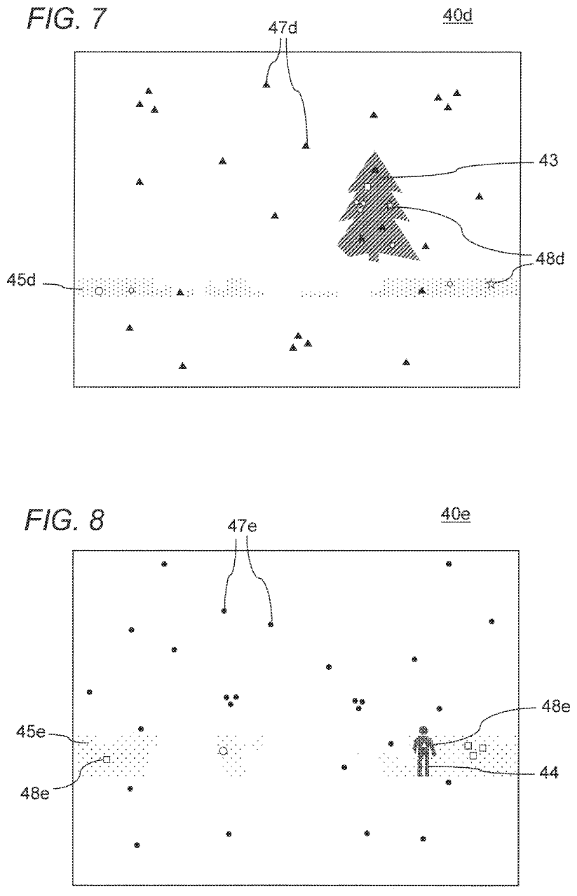

FIG. 7 is a diagram illustrating a pixel group 40d corresponding to the distance interval D4, included in the distance image 40 of FIG. 3. The pixel group 40d includes the pixels corresponding to an object 43, a ground 45d, noises 47d, and defective pixels 48d.

FIG. 8 is a diagram illustrating a pixel group 40e corresponding to the distance interval D5, included in the distance image 40 of FIG. 3. The pixel group 40e includes the pixels corresponding to an object 44, a ground 45e, noises 47e, and defective pixels 48e.

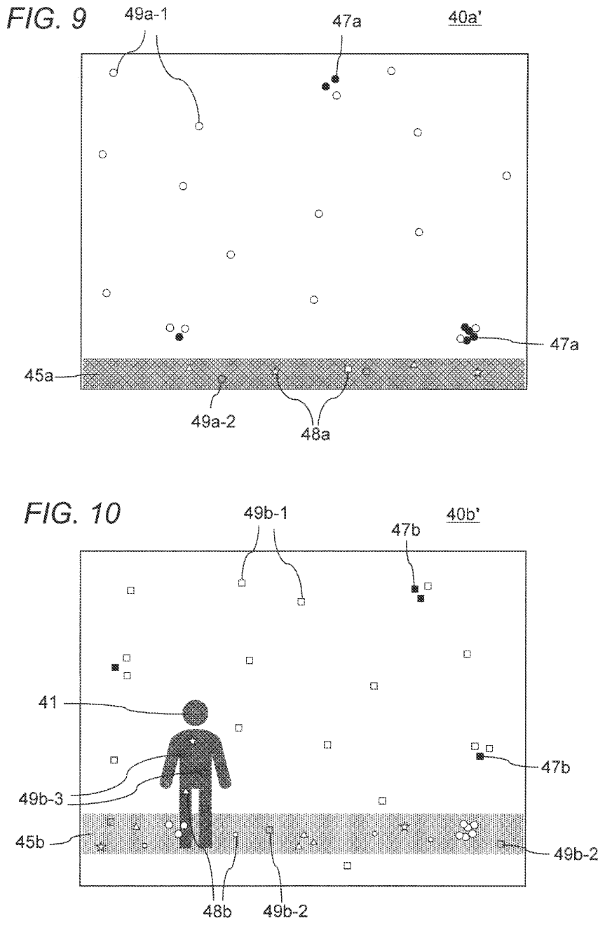

As will be described below with reference to FIGS. 9 to 13, the noise filter 25 individually processes the pixel groups 40a to 40e to reduce the noises in the pixel groups 40a to 40e.

FIG. 9 is a diagram illustrating a pixel group 40a′ obtained by processing the pixel group 40a of FIG. 4 using the noise filter 25. The distance values of the most pixels of the noises 47a in FIG. 4 are corrected by filtering in accordance with the pixel values of their surrounding pixels, and the pixels of the noises 47a are replaced with corrected pixels having the corrected distance values. In the example as shown in FIG. 9, when the pixels of the noises 47a are surrounded by pixels having the distance value of zero, the pixels of the noises 47a are replaced with corrected pixels 49a-l having the distance value of zero, through the filtering. Furthermore, when the noises 47a appear on the ground 45a, the pixels of the noises 47a are replaced with corrected pixels 49a-2 having the same distance values as the distance values of the pixels of the ground 45a, through the filtering. However, when the plurality of noises 47a appear closely or densely to each other, it is difficult to correct the pixels of the noises 47a through the filtering, and therefore, the noises 47a may remain there.

FIG. 10 is a diagram illustrating a pixel group 40b′ obtained by processing the pixel group 40b of FIG. 5 using the noise filter 25. The distance values of the most pixels of the noises 47b in FIG. 5 are corrected by the filtering in accordance with the pixel values of their surrounding pixels, and the pixels of the noises 47b are replaced with corrected pixels having the corrected distance values. In the example as shown in FIG. 10, when the pixels of the noises 47b are surrounded by the pixels having the distance value of zero, the pixels of the noises 47b are replaced with corrected pixels 49b-1 having the distance value of zero, through the filtering. In addition, when the noises 47b appear on the ground 45b, the pixels of the noises 47b are replaced with corrected pixels 49b-2 having the same distance values as the distance values of the pixels of the ground 45b, through the filtering. In addition, when the noises 47b appear on the object 41, the pixels of the noises 47b are replaced with corrected pixels 49b-3 having the same distance value as the distance value of the pixels of the object 41, through the filtering. However, when the plurality of noises 47b appear closely or densely to each other, it is difficult to correct the pixels of the noises 47b through the filtering, and therefore, the noises 47b may remain there.

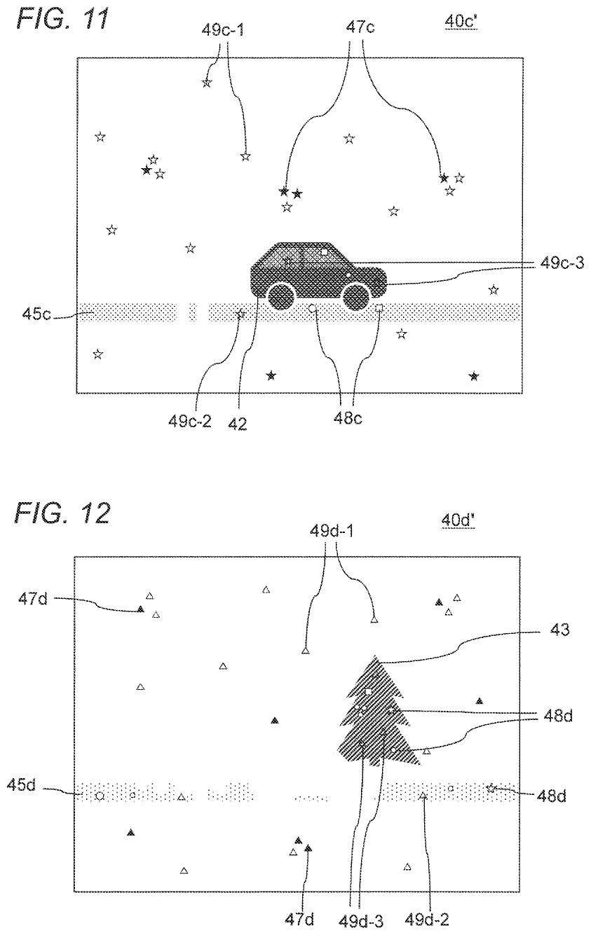

FIG. 11 is a diagram illustrating a pixel group 40c′ obtained by processing the pixel group 40c of FIG. 6 using the noise filter 25. The distance values of the most pixels of the noises 47c in FIG. 6 are corrected by the filtering in accordance with the pixel values of the surrounding pixels, and the pixels of the noises 47c are replaced with corrected pixels having the corrected distance values. In the example as shown in FIG. 11, when the pixels of the noises 47c are surrounding by the pixels having the distance value of zero, the pixels of the noises 47c are replaced with corrected pixels 49c-1 having the distance value of zero, through the filtering. In addition, when the noises 47c appear on the ground 45c, the pixels of the noises 47c are replaced with corrected pixels 49c-2 having the same distance values as the distance values of the pixels of the ground 45c, through the filtering. In addition, when the noises 47c appear on the object 42, the pixels of the noises 47c are replaced with corrected pixels 49c-3 having the same distance value as the distance value of the pixels of the object 42, through the filtering. However, when the plurality of noises 47c appear closely or densely to each other, it is difficult to correct the pixels of the noises 47c through the filtering, and therefore, the noises 47c may remain there.

FIG. 12 is a diagram illustrating a pixel group 40d′ obtained by processing the pixel group 40d of FIG. 7 using the noise filter 25. The distance values of the most pixels of the noises 47d in FIG. 7 are corrected by the filtering in accordance with the pixel values of their surrounding pixels, and the pixels of the noises 47d are replaced with corrected pixels having the corrected distance values. In the example as shown in FIG. 12, when the pixels of the noises 47d are surrounded by the pixels having the distance value of zero, the pixels of the noises 47d are replaced with corrected pixels 49d-1 having the distance value of zero, through the filtering. In addition, when the noises 47d appear on the ground 45d, the pixels of the noises 47d are replaced with corrected pixels 49d-2 having the same distance values as the distance values of the pixels of the ground 45d, the through filtering. In addition, when the noises 47d appear on the object 43, the pixels of the noises 47d are replaced with corrected pixels 49d-3 having the same distance value as the distance value of the pixels of the object 43, through the filtering. However, when the plurality of noises 47d appear closely or densely to each other, it is difficult to correct the pixels of the noises 47d through the filtering, and therefore, the noises 47d may remain there.

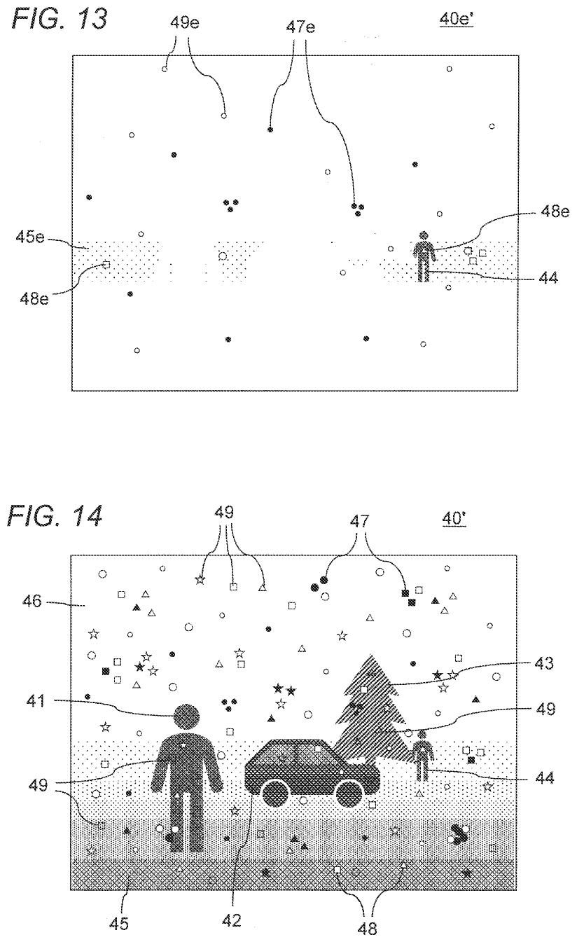

FIG. 13 is a diagram illustrating a pixel group 40e′ obtained by processing the pixel group 40e of FIG. 8 using the noise filter 25. The distance values of most pixels of the noises 47e in FIG. 8 are corrected by the filtering in accordance with the pixel values of their surrounding pixels, and the pixels of the noises 47e are replaced with corrected pixels having the corrected distance values. In the example as shown in FIG. 13, when the pixels of the noises 47e are surrounded by the pixels having the distance value of zero, the pixels of the noises 47e are replaced with corrected pixels 49e having the distance value of zero, through the filtering. However, when the plurality of noises 47e appear closely or densely to each other, it is difficult to correct the pixels of the noises 47e through the filtering, and therefore, the noises 47e may remain there.

FIG. 14 is a diagram illustrating a distance image 40′ obtained by combining the pixel groups 40a′ to 40e′ of FIGS. 9 to 13. The distance image 40′ includes the noises 47 corresponding to the noises 47a to 47e in FIGS. 9 to 13, the defective pixels 48 corresponding to the defective pixels 48a to 48e in FIGS. 9 to 13, and the corrected pixels 49 corresponding to the corrected pixels 49a to 49e in FIGS. 9 to 13.

If a pixel belonging to a pixel group and the same pixel belonging to a different pixel group are corrected to have non-zero distance values through the filtering (or through interpolation as described below), the distance values of the pixel belonging these pixel groups may conflict with each other when combining these pixel groups. In such a case, the reliability of the pixel is calculated based on the number of neighboring pixels, and the distance value having the maximum likelihood is selected.

By individually processing the pixel groups 40a to 40e as described with reference to FIGS. 9 to 13, the density of the noises 47 is reduced, and therefore, it becomes easier to reduce or remove the noises 47. In addition, since the density of the noises 47 is reduced, the filtering is less likely to interfere with the object 41 to 44. As a result, it is possible to reliably reduce the noises in the distance image, without amplifying the noises nor increasing the defective pixels.

In the example as shown in FIGS. 9 to 13, the filter parameters for the pixel groups 40a′ to 40e′ are set such that the noise reduction performance of the noise filter 25 decreases as the representative distance value of the pixel group increases. An object remote from the image capture device 1 is more susceptible to the defective pixels 48 than an object close to the image capture device 1. As described above, by setting the performance of the noise filter 25 based on the distance, it is possible to avoid increasing the defective pixels 48 in the object remote from the image capture device 1.

### Advantageous Effects and Others of First Embodiment

According to an aspect of the present disclosure, an image processing apparatus 2 is provided with an input interface 21, an image divider 24, a noise filter 25, and an image combiner 26. The input interface 21 acquires a first distance image including a plurality of pixels, each of the plurality of pixels indicating a distance value from an image capture device 1 to each point of an object. The image divider 24 divides the first distance image into a plurality of pixel groups based on the distance values of the pixels, such that each of the plurality of pixel groups includes pixels having distance values falling within one of a plurality of distance intervals different from each other. The noise filter 25 individually processes the plurality of pixel groups using a plurality of filter parameters different for the plurality of pixel groups, to reduce noises in the plurality of pixel groups. The image combiner 26 combines the plurality of pixel groups processed by the noise filter 25, with each other, to generate a second distance image.

With such a configuration, it is possible to reliably reduce the noises in the distance image, without amplifying the noises nor increasing the defective pixels.

According to an aspect of the present disclosure, each of the plurality of pixel groups has a representative distance value representative of the distance values of the pixels belonging to the pixel group. The plurality of filter parameters may be set such that noise reduction performance of the noise filter 25 decreases as the representative distance value of the pixel group increases.

With such a configuration, it is possible to avoid increasing the defective pixels in the object remote from the image capture device 1.

According to an aspect of the present disclosure, the image processing apparatus 2 may be provided with at least one processor that operates as the image divider 24, the noise filter 25, and the image combiner 26.

With such a configuration, the image processing apparatus 2 can be implemented using one or more general-purpose processors or dedicated processors.

According to an aspect of the present disclosure, an image processing method includes acquiring a first distance image including a plurality of pixels, each of the plurality of pixels indicating a distance value from an image capture device 1 to each point of an object. The method further includes dividing the first distance image into a plurality of pixel groups based on the distance values of the pixels, such that each of the plurality of pixel groups includes pixels having distance values falling within one of a plurality of distance intervals different from each other. The method further includes individually processing the plurality of pixel groups using a plurality of filter parameters different for the plurality of pixel groups, to reduce noises in the plurality of pixel groups. The method further includes combining the plurality of processed pixel groups with each other to generate a second distance image.

With such a configuration, it is possible to reliably reduce the noises in the distance image, without amplifying the noises nor increasing the defective pixels.

### Second Embodiment

### Configuration of Second Embodiment

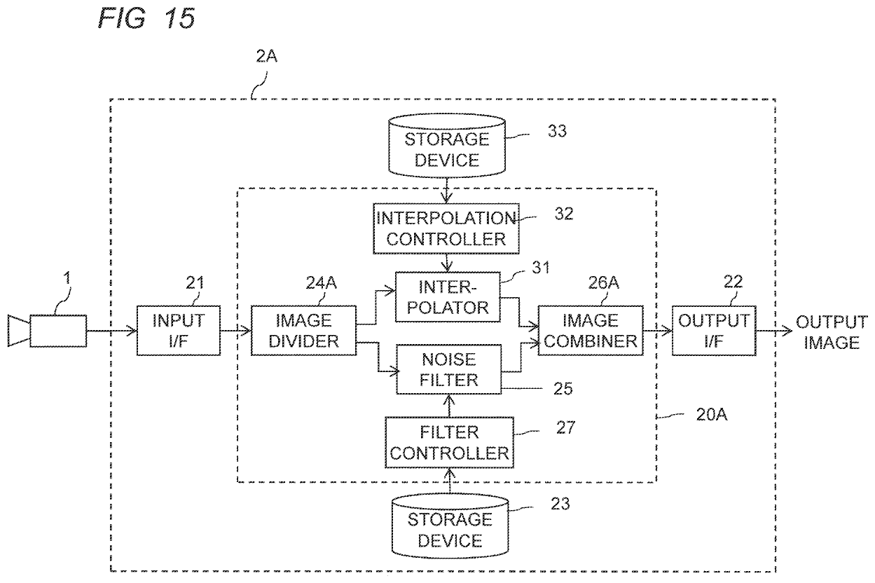

FIG. 15 is a schematic diagram illustrating a configuration of an image processing apparatus 2A according to a second embodiment. The image processing apparatus 2A is provided with a processing circuit 20A instead of the processing circuit 20 of FIG. 1, and further provided with a storage device 33. The processing circuit 20A is provided with an image divider 24A and an image combiner 26A, instead of the image divider 24 and the image combiner 26 of FIG. 1, and further provided with an interpolator 31 and an interpolation controller 32.

The image divider 24A acquires a distance image from the image capture device 1 via the input interface 21, and divides the distance image into a plurality of pixel groups based on the distance values of the pixels, in the similar manner as that of the image divider 24 of FIG. 1. The image divider 24A passes a part of the divided pixel groups to the interpolator 31, and passes the other pixel groups to the noise filter 25. For example, the image divider 24A may pass pixel groups having relatively small representative distance values, to the noise filter 25, and pass pixel groups having relatively large representative distance values, to the interpolator 31.

The interpolator 31 processes at least one of the plurality of pixel groups using an interpolation parameter, to interpolate defective pixels in the pixel group. When processing a plurality of pixel groups, the interpolator 31 may individually process the plurality of pixel groups using a plurality of interpolation parameters different for the plurality of pixel groups, to reduce the noises in the plurality of pixel groups. In such a case, the interpolator 31 may process the plurality of pixel groups sequentially, or process the plurality of pixel groups in parallel.

The plurality of interpolation parameters for one or more pixel groups are stored in the storage device 33 in advance. The plurality of interpolation parameters are set, for example, such that the performance of the interpolator 31 for interpolating defective pixels increases as the representative distance value of the pixel group increases.

The interpolation controller 32 reads the interpolation parameter(s) from the storage device 33, and sets the interpolation parameter(s) to the interpolator 31. When processing the plurality of pixel groups, the interpolation controller 32 sets the interpolation parameters to the interpolator 31 per pixel group.

The image combiner 26A generates a distance image by combining the pixel groups processed by the noise filter 25, and the pixel groups processed by the interpolator 31, with each other.

The processing circuit 20A may be provided with a plurality of dedicated circuits corresponding to the image divider 24A, the noise filter 25, the image combiner 26A, the filter controller 27, the interpolator 31, and the interpolation controller 32, respectively. Alternatively, the processing circuit 20A may be provided with one or more general-purpose processors or dedicated processors (e.g., a digital signal processor) which, when executing a program, operates as the image divider 24A, the noise filter 25, the image combiner 26A, the filter controller 27, the interpolator 31, and the interpolation controller 32. The storage devices 23 and 33 may be provided separately, or may be integrated with each other.

### Operation of Second Embodiment

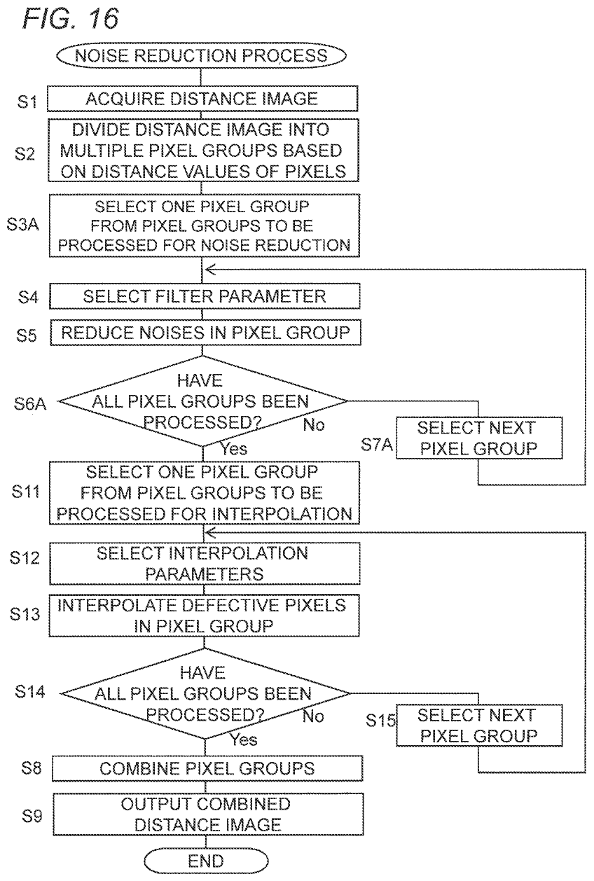

FIG. 16 is a flowchart illustrating noise reduction process executed by the processing circuit 20A of FIG. 15. The noise reduction process of FIG. 16 includes steps S3A, S6A, and S7A, instead of steps S3, S6, and S7 of FIG. 2, and further includes steps S11 to S15.

The processing circuit 20A executes steps S1 to S2 of FIG. 16 in a similar manner as that of steps S1 to S2 of FIG. 2.

The processing circuit 20A then selects one pixel group from the pixel groups to be processed for the noise reduction (step S3A). The pixel groups to be processed for the noise reduction may be, for example, pixel groups 40a to 40c having relatively small representative distance values, among the pixel groups 40a to 40e of FIGS. 4 to 8.

The processing circuit 20A then performs steps S4 to S5 of FIG. 16 in a similar manner as that of steps S4 to S5 of FIG. 2.

The processing circuit 20A then determines whether or not all the pixel groups to be processed for the noise reduction have been processed to reduce noises (step S6A): if YES, the process proceeds to step S11; and if NO, the process proceeds to step S7A.

The processing circuit 20A selects a next unselected pixel group from the pixel groups to be processed for the noise reduction (step S7A), and then, repeats steps S4, S5, and S6A.

Steps S3A, S5, S6A, and S7A correspond to the operation of the processing circuit 20A as the noise filter 25, and step S4 correspond to the operation of the processing circuit 20A as the filter controller 27.

The processing circuit 20A then selects one pixel group from the pixel groups to be processed for the interpolation (step S11). The pixel group to be processed for the interpolation may be, for example, pixel groups 40d and 40e having relatively large representative distance values, among the pixel groups 40a to 40e of FIGS. 4 to 8.

The processing circuit 20A then selects and sets the interpolation parameter corresponding to the pixel group selected in step S11 (step S12).

The processing circuit 20A then processes the pixel group to interpolate the defective pixels in the pixel group, using the set interpolation parameter being set (step S13).

The processing circuit 20A then determines whether all the pixel groups to be processed for the interpolation have been processed to interpolate defective pixels (step S14): if YES, the process proceeds to step S8; and if NO, the process proceeds to step S15.

The processing circuit 20A then selects a next unselected pixel group from the pixel groups to be processed for the interpolation (step S15), and then, repeats steps S12 to S14.

Steps S11 and S13 to S15 correspond to the operation of the processing circuit 20A as the interpolator 31, and step S12 corresponds to the operation of the processing circuit 20A as the interpolation controller 32.

The processing circuit 20A then performs steps S8 to S9 of FIG. 16 in a similar manner as that of steps S8 to S9 of FIG. 2.

In the example as shown in FIG. 16, the processing circuit 20A performs steps S11 to S15 after steps S3A to S7. However, the processing circuit 20A may perform steps S11 to S15 before steps S3A to S7. Alternatively, the processing circuit 20A may also perform steps S11 to S15 in parallel to steps S3A to S7.

With the noise reduction process of FIG. 16, it is possible to reduce noises in the distance image, and also interpolate the defective pixels in the distance image.

By individually processing the plurality of pixel groups, the density of the defective pixels is reduced, and therefore, it becomes easier to interpolate the defective pixels. Furthermore, since the density of the defective pixels is reduced, the interpolation is less likely to interfere with the objects. As a result, it is possible to reliably interpolate the defective pixels in the distance image, without amplifying the noises nor increasing the defective pixels.

While the objects remote from the image capture device 1 are less susceptible to noises, the objects close to the image capture device 1 are more susceptible to noises. On the other hand, while the objects remote from the image capture device 1 are more susceptible to defective pixels, the objects close to the image capture device 1 are less susceptible to defective pixels. Therefore, by selectively applying either filtering or interpolation based on the distance from the image capture device 1 to the objects, for example, it is possible to effectively reduce noises on the objects close to the image capture device 1, and also effectively interpolate defective pixels on the objects remote from the image capture device 1.

In addition, by setting the interpolation parameters such that the performance of the interpolator 31 for interpolating defective pixels increases as the representative distance value of the pixel, group increases, it is possible to effectively interpolate defective pixels on the objects remote from the image capture device 1.

### Advantageous Effects and Others of Second Embodiment

According to an aspect of the present disclosure, the image processing apparatus 2A may be further provided with an interpolator 31 that processes at least one of the plurality of pixel groups using a interpolation parameter, to interpolate defective pixels in the pixel group. In this case, the image combiner 26A generates the second distance image by combining the plurality of pixel groups processed by the noise filter 25, and the at least one pixel group processed by the interpolator 31, with each other.

With such a configuration, it is possible to reduce noises in the distance image, and also interpolate the defective pixels in the distance image.

According to an aspect of the present disclosure, each of the plurality of pixel groups has a representative distance value representative of the distance values of the pixels belonging to the pixel group. In this case, the interpolation parameter may be set such that performance of the interpolator 31 for interpolating defective pixels increases as the representative distance value of the pixel group increases.

With such a configuration, it is possible to effectively interpolate defective pixels on the objects remote from the image capture device 1.

### Third Embodiment

### Configuration of Third Embodiment

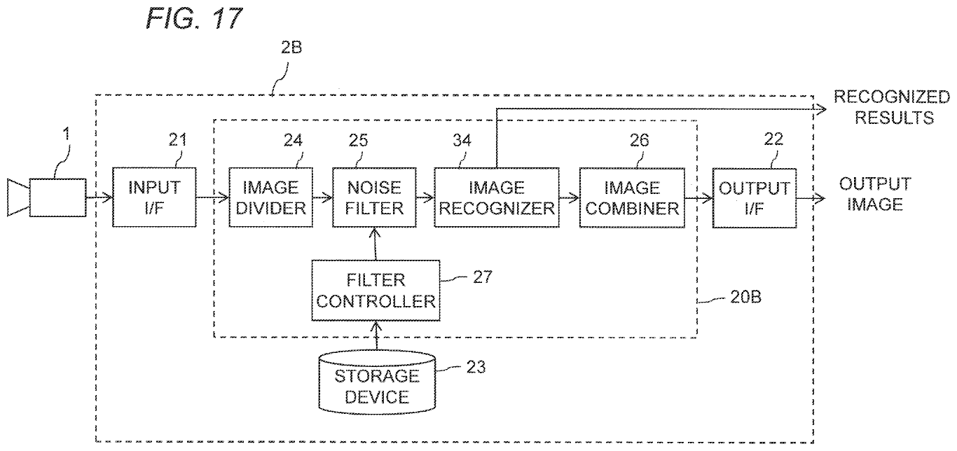

FIG. 17 is a schematic diagram illustrating a configuration of an image processing apparatus 2B according to a third embodiment. The image processing apparatus 2B is provided with a processing circuit 20B instead of the processing circuit 20 of FIG. 1. The processing circuit 20B is provided with an image recognizer 34, in addition to the constituent elements of the processing circuit 20 of FIG. 1.

The image recognizer 34 recognizes predetermined objects, such as persons or vehicles, in each of the plurality of pixel groups processed by the noise filter 25. By applying the image recognition to a pixel group corresponding to a certain distance interval, it is possible to more accurately recognize the objects included in the distance image, as compared with the case in which the image recognition is applied to the distance image combined by the image combiner 26.

The processing circuit 20B may be provided with a plurality of dedicated circuits corresponding to the image divider 24, the noise filter 25, the image combiner 26, the filter controller 27, and the image recognizer 34, respectively. Alternatively, the processing circuit 20B may be provided with one or more general-purpose processors or dedicated processors (such as a digital signal processor) which, when executing a program, operates as the image divider 24, the noise filter 25, the image combiner 26, and the filter controller 27, and the image recognizer 34, respectively.

### Advantageous Effects and Others of Third Embodiment

According to an aspect of the present disclosure, the image processing apparatus 2B may be further provided with a first image recognizer 34 that recognizes a predetermined object in each of the plurality of pixel groups processed by the noise filter 25.

With such a configuration, it is possible to more accurately recognize the objects included in the distance image, as compared with the case in which the image recognition is applied to the distance image.

### Fourth Embodiment

### Configuration of Fourth Embodiment

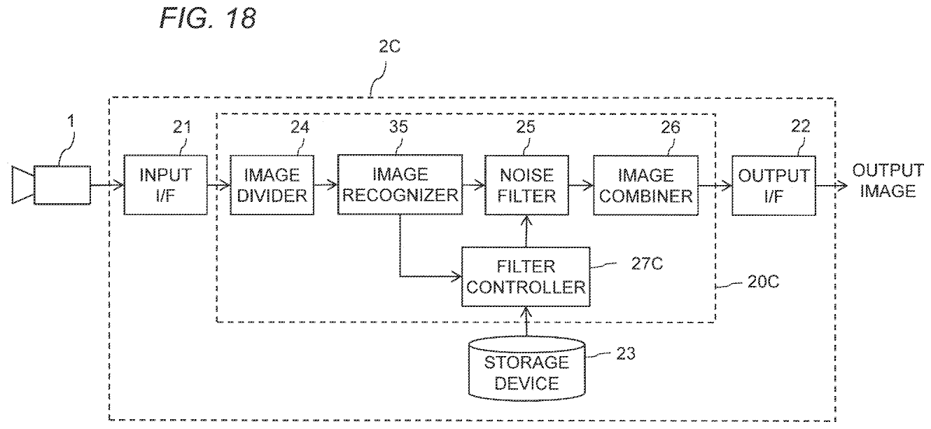

FIG. 18 is a schematic diagram illustrating a configuration of an image processing apparatus 2C according to a fourth embodiment. The image processing apparatus 2C is provided with a processing circuit 20C instead of the processing circuit 20 of FIG. 1. The processing circuit 20C is provided with a filter controller 27C instead of the filter controller 27 of FIG. 1, and further provided with an image recognizer 35.

The image recognizer 35 recognizes predetermined objects in each of the plurality of pixel groups prior to being processed by the noise filter 25.

The filter controller 27C sets filter parameters based on the distance from the image capture device 1 to the objects recognized by the image recognizer 35, such that an appropriate filter parameter is applied to a pixel group including a recognized object. For example, the filter controller 27C may set filter parameters based on the distance of the recognized object, so as to decrease the performance of the noise filter 25 a pixel group including the object, and increase the performance of the noise filter 25 for a pixel group not including the object. As a result, it is possible to adjust the performance of the noise filter 25 so as not to blur important objects.

Instead of based on the distances of the recognized objects, for example, the filter controller 27C may set the filter parameters based on apparent sizes of the objects in a similar manner as that of the distances of the objects.

By adaptively setting the filter parameters based on the distances from the image capture device 1 to the objects, it is possible to more reliably reduce the noises in the distance image.

The processing circuit 20C may be provided with a plurality of dedicated circuits corresponding to the image divider 24, the noise filter 25, the image combiner 26, the filter controller 27C, and the image recognizer 35, respectively. Alternatively, the processing circuit 20C may be provided with one or more general-purpose processors or dedicated processors (such as a digital signal processor) which, when executing a program, operates as the image divider 24, the noise filter 25, the image combiner 26, and the filter controller 27C, and the image recognizer 35, respectively.

### Advantageous Effects and Others of Fourth Embodiment

According to an aspect of the present disclosure, the image processing apparatus 2C may be further provided with a second image recognizer 35 and a filter controller 27. In this case, the second image recognizer 35 recognizes a predetermined object in each of the plurality of pixel groups before being processed by the noise filter 25. The filter controller 27 sets a filter parameter to be applied to a pixel group including the object, based on a distance from the image capture device 1 to the object recognized by the second image recognizer 35.

With such a configuration, it is possible to more reliably reduce the noises in the distance image.

### Other Embodiments

As described above, the embodiments have been described as examples of the technology disclosed in the present application. However, the technology in the present disclosure is not limited thereto, and is applicable to embodiments with some changes, replacements, additions, omissions, and the like. In addition, new embodiments can be derived by combining the constituent elements described in the aforementioned embodiments.

Thus, other embodiments will be exemplified below.

The image processing apparatus 2, etc., may process the distance image acquired from the image capture device 1 in real time, or may read and process the distance image temporarily stored in an external storage device.

The storage device 23 and the filter controller 27 may be omitted, when the image processing apparatus 2, etc., is provided with a plurality of parallel filter circuits to which predetermined filter parameters are set, respectively.

The plurality of filter parameters may be set, for example, such that the noise reduction the performance of the noise filter 25 gradually increases and then gradually decreases as the representative distance value of the pixel group increases.

In addition, the filter parameters may be set in consideration of characteristics of the lens of the image capture device 1.

There may be a predetermined number of distance intervals being divided. Alternatively, there may be distance intervals being adaptively divided based on the distribution of the distances of the objects.

According to the example explained in the second embodiment, only one of the noise filtering and the interpolation is applied to each of the pixel groups. However, both the noise filtering and the interpolation may be applied to at least one pixel group.

The image processing apparatus 2, etc., is also applicable to, for example, a three-dimensional measurement system for quantifying information used to analyze or optimize a work site. For example, when modelling the volume of loads on a cart or a truck carrier in a logistics warehouse using distance images to quantify the ratio of actual loads to maximum loads, the accuracy of three-dimensional measurement may degrade due to noises in acquired distance images, and thus, accurate modeling may be hindered. On the other hand, the image processing apparatus and the image processing method according to one aspect of the present disclosure can reliably reduce the noises in the distance image, thus achieving accurate three-dimensional measurement.

The embodiments described above may be combined with each other. For example, the image processing apparatus 2C of FIG. 18 may be further provided with the image recognizer 34 of FIG. 17. In addition, the image processing apparatus 2A of FIG. 15 may be provided with at least one of the image recognizer 34 of FIG. 17, and the filter controller 27C and the image recognizer 35 of FIG. 18.

As described above, the embodiments have been described as examples of the technology according to the present disclosure. The accompanying drawings and the detailed description have been provided for this purpose.

Accordingly, the constituent elements described in the accompanying drawings and the detailed description may include not only constituent elements essential to solving the problem, but also constituent elements not essential to solving the problem, in order to exemplify the technology. Therefore, even when those non-essential constituent elements are described in the accompanying drawings and the detailed description, those non-essential constituent elements should not be considered essentials.

In addition, since the above-described embodiments are intended to exemplify the technology of the present disclosure, it is possible to make various changes, replacements, additions, omissions, and the like within the scope of claims or the equivalent thereof.

The image processing apparatus and the image processing method according to the aspect of the present disclosure can be applied to reduce random noises in the distance image.

1. An image processing apparatus comprising:
an input interface that acquires a first distance image including a plurality of pixels, each of the plurality of pixels indicating a distance value from an image capture device to each point of an object;
an image divider that divides the first distance image into a plurality of pixel groups based on the distance values of the pixels, such that each of the plurality of pixel groups includes pixels having distance values falling within one of a plurality of distance intervals different from each other;
a noise filter that individually processes the plurality of pixel groups using a plurality of filter parameters different for the plurality of pixel groups, to reduce noises in the plurality of pixel groups; and
an image combiner that combines the plurality of pixel groups processed by the noise filter, with each other, to generate a second distance image.

2. The image processing apparatus according to claim 1,
wherein each of the plurality of pixel groups has a representative distance value representative of the distance values of the pixels belonging to the pixel group, and
wherein the plurality of filter parameters are set such that noise reduction performance of the noise filter decreases as the representative distance value of the pixel group increases.

3. The image processing apparatus according to claim 1, comprising at least one processor that operates as the image divider, the noise filter, and the image combiner.

4. The image processing apparatus according to claim 1, further comprising an interpolator that processes at least one of the plurality of pixel groups using a interpolation parameter, to interpolate defective pixels in the pixel group,
wherein the image combiner generates the second distance image by combining the plurality of pixel groups processed by the noise filter, and the at least one pixel group processed by the interpolator, with each other.

5. The image processing apparatus according to claim 4,
wherein each of the plurality of pixel groups has a representative distance value representative of the distance values of the pixels belonging to the pixel group, and
wherein the interpolation parameter is set such that performance of the interpolator for interpolating defective pixels increases as the representative distance value of the pixel group increases.

6. The image processing apparatus according to claim 1, further comprising a first image recognizer that recognizes a predetermined object in each of the plurality of pixel groups processed by the noise filter.

7. The image processing apparatus according to claim 1, further comprising:
a second image recognizer that recognizes a predetermined object in each of the plurality of pixel groups before being processed by the noise filter; and
a filter controller that sets a filter parameter to be applied to a pixel group including the object, based on a distance from the image capture device to the object recognized by the second image recognizer.

8. An image processing method including:
acquiring a first distance image including a plurality of pixels, each of the plurality of pixels indicating a distance value from an image capture device to each point of an object;
dividing the first distance image into a plurality of pixel groups based on the distance values of the pixels, such that each of the plurality of pixel groups includes pixels having distance values falling within one of a plurality of distance intervals different from each other;
individually processing the plurality of pixel groups using a plurality of filter parameters different for the plurality of pixel groups, to reduce noises in the plurality of pixel groups; and
combining the plurality of processed pixel groups with each other to generate a second distance image.
